(19) United States
(12) Patent Application Publication
(10) Pub. No.: US 2017/0043743 A1
(43) Pub. Date: Feb. 16, 2017

(54) GAS GENERATOR

(71) Applicant: DAICEL CORPORATION, Osaka-shi, Osaka (JP)

(72) Inventors: Tomoharu KOBAYASHI, Tatsuno-shi (JP); Masayuki YAMAZAKI, Tatsuno-shi (JP); Kenji FUKUMOTO, Tatsuno-shi (JP)

(73) Assignee: Daicel Corporation, Osaka-shi, Osaka (JP)

(21) Appl. No.: 15/305,712

(22) PCT Filed: May 14, 2015
(86) PCT No.: PCT/JP2015/063854

§ 371 Date: Oct. 21, 2016

(30) Foreign Application Priority Data
May 28, 2014 (JP) 2014-110264

(51) Int. Cl. B60R 21/274

(52) U.S. Cl. CPC B60R 21/274; B60R 2021/26076

(57) ABSTRACT

The present invention provides a gas generator including: a cylindrical housing having an ignition device which is fixed to an opening at a first end, and a second end which is closed, the inside of the cylindrical housing being provided with an ignition device chamber, a gas inflow chamber and a pressurized gas chamber, these chambers being arranged in the above order from the first end; a rupturable plate closing a gas outflow port between the pressurized gas chamber and the gas inflow chamber; and a breaking device arranged between the ignition device chamber and the gas inflow chamber, the breaking device including a base and a rod extending from the base towards the rupturable plate, the rod including a rod main body portion and a rod enlarged-diameter portion at a distal end portion thereof, the rod enlarged-diameter portion including a distal end surface portion facing the rupturable plate and a circumferential wall portion, the distal end surface portion of the rod enlarged-diameter portion including a breaking portion and a non-breaking portion for the rupturable plate, the non-breaking portion being a concave portion which is formed in a portion including a circumferential region of the distal end surface portion and concaved in a thickness direction, a circumferential extent in which the non-breaking portion is formed as the concave portion being in such a range that an angle around the center of the distal end surface portion is not more than 100 degrees.

### TECHNICAL FIELD

The present invention relates to a gas generator for an airbag apparatus to be installed on a vehicle, in which a pressurized gas is used.

### DESCRIPTION OF RELATED ART

In FIG. 1 of JP-A No. H09-58394, a gas generating device for an airbag apparatus is disclosed, in which a pressurized gas and a gas generating agent are used as a gas source.

In the gas generating device depicted in FIG. 1, the inside of a gas cylinder 15 is filled with a pressurized gas, and the gas generating device is actuated when a piston 22 moves, due to the actuation of a detonating member 32, to a bottle sealed with a seal plate 17 and opens an opening of the gas cylinder 15.

A cutting blade 23 (FIG. 6) is disposed at a distal end portion of the piston 22, and the cutting blade 23 has a semicircular cross-sectional shape.

Under the effect of the filled gas, the seal plate 17 is deformed convexly (a convex portion 37) toward the cutting blade 23 (FIGS. 3 and 4). At the time of actuation, the cutting blade 23 collides with a boundary portion between the convex portion 37 and a flat plate portion 36 of the seal plate 17 and cuts the boundary portion in a semicircular fashion, and the boundary portion is bent toward the piston 22 from the uncut portion by the outflow of the gas in the gas cylinder 15 (FIG. 9).

### SUMMARY OF INVENTION

The Invention 1 of the present invention provides a gas generator, including:

a cylindrical housing having an ignition device which is fixed to an opening at a first end, and a second end which is closed on an axially opposite side of the first end, the inside of the cylindrical housing being provided with an ignition device chamber provided with the ignition device, a gas inflow chamber having a gas discharge port and a pressurized gas chamber, these chambers being arranged in the above order from the first end;

a rupturable plate closing a gas outflow port between the pressurized gas chamber and the gas inflow chamber; and

a breaking device arranged between the ignition device chamber and the gas inflow chamber, the breaking device including, a base, whose outer circumferential surface abuts against an inner wall surface of the cylindrical housing, and a rod extending from the base towards the rupturable plate, the rod including a rod main body portion and a rod enlarged-diameter portion with a diameter enlarged radially at a distal end portion of the rod main body portion,

the rod enlarged-diameter portion including a distal end surface portion facing the rupturable plate and a circumferential wall portion extending from the distal end surface portion to the rod main body portion,

the distal end surface portion of the rod enlarged-diameter portion including a breaking portion and a non-breaking portion for the rupturable plate,

the non-breaking portion being a concave portion which is formed in a portion including a circumferential region of the distal end surface portion and being concaved in a thickness direction, and the breaking portion corresponding to the remaining portion of the distal end surface portion excluding the concave portion,

a circumferential extent in which the non-breaking portion is formed as the concave portion being in such a range that an angle around the center of the distal end surface portion is not more than 100 degrees.

The Invention 2 of the present invention provides a gas generator, including:

a cylindrical housing having an ignition device which is fixed to an opening at a first end, and a second end which is closed on an axially opposite side of the first end, the inside of the cylindrical housing being provide with an ignition device chamber provided with the ignition device, a gas inflow chamber having a gas discharge port and a pressurized gas chamber, these chambers being arranged in the above order from the first end;

a rupturable plate closing a gas outflow port between the pressurized gas chamber and the gas inflow chamber; and

a breaking device arranged between the ignition device chamber and the gas inflow chamber, the breaking device including a base, whose outer circumferential surface abuts against an inner wall surface of the cylindrical housing, and a rod extending from the base towards the rupturable plate, the rod including a rod main body portion and a rod enlarged-diameter portion with a diameter enlarged radially at a distal end portion of the rod main body portion,

the rod enlarged-diameter portion including a distal end surface portion facing the rupturable plate and a circumferential wall portion extending from the distal end surface portion to the rod main body portion,

the distal end surface portion of the rod enlarged-diameter portion including a breaking portion and a non-breaking portion for the rupturable plate,

the non-breaking portion of the distal end surface portion of the rod enlarged-diameter portion being a cut portion that is cut in a direction perpendicular or oblique to the distal end surface portion of the rod enlarged-diameter portion, and the breaking portion being a remaining portion of the distal end surface portion excluding the cut portion,

a circumferential extent in which the non-breaking portion is formed as the cut portion being in such a range that an angle around the center of the distal end surface portion is less than 180 degrees.

### BRIEF DESCRIPTION OF DRAWINGS

The present invention will become more fully understood from the detailed description given hereinbelow and the accompanying drawings which are given by way of illustration only, and thus are not limitative of the present invention and wherein:

FIG. 1 shows a cross-sectional view in the X-axis direction of a gas generator of the present invention;

FIG. 2 shows, in (a), a state before an actuation in a partially enlarged view of FIG. 1, and in (b), a state after the actuation in a partially enlarged view of FIG. 1;

FIG. 3 shows, in (a) to (f), a front view illustrating embodiments of a rod (a rod main body portion and a rod enlarged-diameter portion) usable for the gas generator of the present invention;

FIG. 4 shows, in (a), a perspective view of a rod (a rod main body portion and a rod enlarged-diameter portion) used in FIG. 1, in (b), a front view of (a), and in (c), a plan view of (a);

FIG. 5 shows a perspective view of a rod (a rod main body portion and a rod enlarged-diameter portion) of an embodiment other than that depicted in FIG. 4;

FIG. 6 shows, in (a) and (b), perspective views of rods (rod main body portions and rod enlarged-diameter portions) of embodiments other than that depicted in FIG. 4;

FIG. 7 shows, in (a), a perspective view of a rod (a rod main body portion and a rod enlarged-diameter portion) of an embodiment other than that depicted in FIG. 4, and in (b), a plan view of (a);

FIG. 8 shows, in (a), a perspective view of a rod (a rod main body portion and a rod enlarged-diameter portion) of an embodiment other than that depicted in FIG. 4, and in (b), a front view of (a);

FIG. 9 shows, in (a) and (b), perspective views of rods (rod main body portions and rod enlarged-diameter portions) of embodiments other than that depicted in FIG. 4;

FIG. 10 shows an axial sectional view illustrating the operation of the gas generator in which a breaking device having the rod depicted in (e) in FIG. 3 is used; and

FIG. 11 shows an axial sectional view illustrating the operation of the gas generator in which a breaking device having the rod depicted in (d) in FIG. 3 is used.

### DETAILED DESCRIPTION OF INVENTION

In JP-A No. H09-58394, when the seal plate 17 is cut by the cutting blade 23, for example, the bending illustrated by FIG. 9 apparently proceeds easily when ⅔ of the boundary portion between a flat portion 36 and the convex portion 37 is cut and ⅓ thereof is not cut.

However, when a half of the boundary portion between the flat portion 36 and the convex portion 37 is cut, a half remains uncut. Therefore, the bending illustrated by FIG. 9 is apparently unlikely to proceed.

Further, even when the bending proceeds as depicted in FIG. 9, the convex portion 37 can come into contact with the piston 22 at the time of bending towards the piston 22, and the opening can be insufficient.

Furthermore, even when the convex portion 37 is bent into the state depicted in FIG. 9, the gas outflow port of the gas cylinder 15 is small and the gas outflow can be impeded.

The present invention provides a gas generator for an airbag apparatus to be installed on a vehicle, in which a pressurized gas is used and that is capable of maintaining the reliability of actuation over the service period of the vehicle.

Describing the Invention 1 of the present invention in detail, the ignition device chamber includes a known electric igniter used in a gas generator for an airbag apparatus. If necessary, a transfer charge or a gas generating agent can be used therewith.

A gas generated from the gas generating agent can be used for airbag deployment.

The pressurized gas chamber is filled with a gas such as argon, helium, or nitrogen under a required pressure.

The gas discharge port is formed in the cylindrical housing at the location where the gas inflow chamber is formed. A cylindrical filter can be disposed at a position such as to cover the gas discharge port from the inside.

The rupturable plate closes the gas outflow port between the pressurized gas chamber and the gas inflow chamber. The peripheral portion of the rupturable plate is fixed by welding to the inner wall surface of the cylindrical housing.

The gas outflow port is an opening between the pressurized gas chamber and the gas inflow chamber before being closed with the rupturable plate. The entire gas outflow port is closed by the rupturable plate.

The breaking device for the rupturable plate is disposed between the ignition device chamber and the gas inflow chamber.

The breaking device includes the base and the rod extending from the base towards the rupturable plate, and the rod has the rod main body portion and the rod enlarged-diameter portion with a diameter enlarged radially at the distal end portion of the rod main body portion.

The outer circumferential surface of the base abuts against the inner wall surface of the cylindrical housing. As a result, the base separates the ignition device chamber from the gas inflow chamber. The outer diameter of the base is almost equal to the inner diameter of the cylindrical housing.

The rod extends from the base towards the rupturable plate. The outer diameter of the rod is sufficiently smaller than the outer diameter of the base.

The rod enlarged-diameter portion has the distal end surface portion facing the rupturable plate and the circumferential wall portion extending from the distal end surface portion to the rod main body portion.

The rod enlarged-diameter portion can be as follows:

(I) The rod enlarged-diameter portion is a disk portion which is larger in outer diameter than the rod main body portion. The surface of the disk portion on the side of the rupturable plate corresponds to the distal end surface portion, and the circumferential surface of the disk portion and the reverse surface with respect to the distal end surface portion correspond to circumferential wall portion.

(II) The rod enlarged-diameter portion is a truncated cone portion extending from the rod main body portion. The surface of the truncated cone portion on the side of the rupturable plate corresponds to the distal end surface portion, and the inclined surface of the truncated cone portion corresponds to the circumferential wall portion.

(III) The rod enlarged-diameter portion includes a disk portion which is larger in outer diameter than the rod main body portion and an inclined surface portion extending from the disk portion to the rod main body portion. The surface of the disk portion on the side of the rupturable plate corresponds to the distal end surface portion, and both the circumferential surface of the disk portion and the inclined surface portion correspond to the circumferential wall portion.

In the rod enlarged-diameter portion, the central axis of the rod and the center of the distal end surface portion may or may not coincide with each other (when the distal end surface portion is not a circle or a regular polygon, the center is an area center).

In the case that the central axis of the rod and the center of the distal end surface portion do not coincide with each other, the rod enlarged-diameter portion is formed by enlarging the diameter only in one direction with respect to the central axis of the rod.

In the distal end surface portion, the portion including the center (when the distal end surface portion is not a circle or a regular polygon, the center is an area center) may recede in the thickness direction or may form the same flat surface.

The distal end surface portion has the breaking portion and the non-breaking portion for the rupturable plate.

The breaking portion of the distal end surface portion for the rupturable plate comes into contact (collides) with the rupturable plate at the time of actuation, and the non-breaking portion of the distal end surface portion for the rupturable plate does not come into contact (does not collide) with the rupturable plate at the time of actuation, or the degree of the contact (collision) thereof is less than that of the breaking portion (that is, the intensity of the impact applied to the rupturable plate is less than that applied by the breaking portion).

The non-breaking portion is a concave portion which is formed in a portion including the circumferential region of the distal end surface portion and concaved in the thickness direction, or a cut portion that is cut in the distal end surface portion of the rod enlarged-diameter portion in a perpendicular direction or an oblique direction. The portion of the distal end surface portion where the concave portion is not present corresponds to the breaking portion.

The concave portion is a notch formed in part of the annular flat portion and is recessed compared to a portion where the notch is not present. The shape of the notch is not particularly limited.

The circumferential extent of the concave portion serving as the non-breaking portion is in such a range that an angle around the center of the distal end surface portion (when the distal end surface portion is not a circle or a regular polygon, the center is an area center) is 100 degrees or less. The concave portion may expand in the radial direction of the distal end surface portion and may extend to the center of the distal end surface portion.

The circumferential extent of the concave portion serving as the non-breaking portion (a width of the notch) may be adjusted within the range of 20 degrees to 100 degrees according to the shape of the notch.

The depth of the concave portion forming the non-breaking portion can be such that the thickness of the non-breaking portion where the concave portion is present is within a range of 0.5 to 0.9 when the thickness of the breaking portion where the concave portion is not present is taken as 1.

The depth of the concave portion may not be uniform. The concave portion can be the deepest in the circumferential edge portion and relatively shallow in the center.

When the breaking device collides with the rupturable plate, the rod enlarged-diameter portion collides with the rupturable plate. At this time, the rupturable plate curved towards the gas outflow/inflow chamber is pushed by the rod and deformed towards the pressurized gas chamber. In this state, a portion (the breaking portion) where the concave portion is not present collides with the rupturable plate and cuts the rupturable plate, while the concave portion (the non-breaking portion) does not collide with the rupturable plate (even if it collides, the impact applied by the concave portion to the rupturable plate at the time of collision is sufficiently smaller by comparison with that applied by the breaking portion). Therefore, the rupturable plate which is directly opposite to the concave portion is not cut.

For this reason, the rupturable plate bends in the uncut portion, and it bends easily compared to the case disclosed in JP-A No. H09-58394.

The maximum outer diameter (d2) of the rod enlarged-diameter portion is slightly smaller than the inner diameter (d1) of the gas outflow port between the pressurized gas chamber and the gas inflow chamber (d1>d2, d1/d2 is a numerical value close to 1).

In the gas generator, the non-breaking portion of the distal end surface portion of the rod enlarged-diameter portion can be a cut portion which is cut perpendicularly through the distal end surface portion of the rod enlarged-diameter portion including the circumferential region.

Similarly to the above-described invention, the circumferential extent of the cut portion serving as the non-breaking portion is in such a range that an angle around the center of the distal end surface portion is 100 degrees or less.

When the breaking device collides with the rupturable plate, the rod enlarged-diameter portion collides with the rupturable plate. At this time, the portion (the breaking portion) where the cut portion is not present collides with and cuts the rupturable plate, while the cut portion (the non-breaking portion) does not collide with the rupturable plate, or even if it collides, the impact applied by the cut portion to the rupturable plate at the time of collision is sufficiently smaller by comparison with that applied by the breaking portion. Therefore, the rupturable plate which is directly opposite to the cut portion is not cut.

In the gas generator, the non-breaking portion of the distal end surface portion of the rod enlarged-diameter portion can be a curved portion formed in a boundary between the distal end surface portion and the circumferential wall portion.

Similarly to the above-described invention, the circumferential extent of the curved portion serving as the non-breaking portion is in such a range that an angle around the center of the distal end surface portion is 100 degrees or less.

When the breaking device collides with the rupturable plate, the rod enlarged-diameter portion collides with the rupturable plate. At this time, the portion where the curved portion is not present (the breaking portion) collides with and cuts the rupturable plate, and even when the curved portion (the non-breaking portion) collides with the rupturable plate, the impact applied by the curved portion to the rupturable plate at the time of collision is sufficiently smaller by comparison with that applied by the breaking portion. Therefore, the rupturable plate which is directly opposite to the cut portion is not cut.

In the gas generator of the above-described invention, the distal end surface portion of the rod enlarged-diameter portion can be a flat surface perpendicular to a central axis of the rod, or a flat surface inclined with respect to the central axis of the rod.

When the distal end surface portion is the perpendicular flat surface, the breaking portion first collides with the rupturable plate, and the non-breaking portion does not collide or collides with delay.

When the distal end surface portion is the inclined surface, in a positional relation with respect to the rupturable plate, an inclined surface portion (a distal end portion), which is the closest to the rupturable plate and an inclined surface portion (a rear end portion), which is the farthest from the rupturable plate, are provided. The distance from the distal end surface portion to the rupturable plate increases from the distal end portion to the rear end portion.

When the distal end surface portion is the inclined surface, the distal end portion first collides with the rupturable plate, and the rear end portion last collides with the rupturable plate.

As for the position of the non-breaking portion when the distal end surface portion is the inclined surface, it is preferable that the non-breaking portion is formed at a portion including the rear end portion, from the standpoint of maintaining an unruptured portion of the rupturable plate when the rupturable plate is ruptured.

The invention 2 of the present invention can provide a gas generator including

a cylindrical housing having an ignition device fixed to an opening at a first end and a second end closed on the axially opposite side of the first end, an ignition device chamber provided with an ignition device, a gas inflow chamber having a gas discharge port and a pressurized gas chamber being arranged in the above order from the first end in the cylindrical housing,

a rupturable plate closing a gas outflow port between the pressurized gas chamber and the gas inflow chamber,

a breaking device being arranged between the ignition device chamber and the gas inflow chamber, the breaking device including a base, whose outer circumferential surface abuts against an inner wall surface of the cylindrical housing, a rod extending from the base towards the rupturable plate and a rod enlarged-diameter portion with a diameter enlarged radially at a distal end portion of the rod,

the rod enlarged-diameter portion including a distal end surface portion facing the rupturable plate and a circumferential wall portion extending from the distal end surface portion to the distal end portion of the rod,

the distal end surface portion of the rod enlarged-diameter portion including a breaking portion and a non-breaking portion for the rupturable plate,

the non-breaking portion of the distal end surface portion of the rod enlarged-diameter portion being a cut portion obtained by cutting in a direction perpendicular or oblique to the distal end surface portion of the rod enlarged-diameter portion, and the breaking portion being the remaining portion of the distal end surface portion excluding the cut portion,

a circumferential extent in which the non-breaking portion is formed as the cut portion being in such a range that an angle around the center of the distal end surface portion is less than 180 degrees.

In the Invention 2 of the present invention, the cut portion corresponds to the non-breaking portion, and the difference from the gas generator of the Invention 1 is that the circumferential extent of the cut portion is in a range of less than 180 degrees.

The circumferential extent of the cut portion serving as the non-breaking portion is preferably in a range of more than 100 degrees to less than 180 degrees, and more preferably 105 degrees to 175 degrees.

In the gas generator of the Invention 2, the distal end surface portion of the rod enlarged-diameter portion can be a flat surface perpendicular to the central axis of the rod, or a flat surface inclined with respect to the central axis of the rod.

When the distal end surface portion is the flat surface, the breaking portion first collides with the rupturable plate, and the non-breaking portion does not collide or it collies with delay.

When the distal end surface portion is the inclined surface, in a positional relation with respect to the rupturable plate, an inclined surface portion (a distal end portion), which is the closest to the rupturable plate, and an inclined surface portion (a rear end portion), which is the farthest from the rupturable plate, are provided. The distance from the distal end surface portion to the rupturable plate increases from the distal end portion to the rear end portion.

When the distal end surface portion is the inclined surface, the distal end portion first collides with the rupturable plate, and the rear end portion last collides with the rupturable plate.

As for the position of the non-breaking portion when the distal end surface portion is the inclined surface, it is preferable that the non-breaking portion is formed in the rear end portion, from the standpoint of maintaining an unruptured portion of the rupturable plate when the rupturable plate is ruptured.

In the Invention 1 and the Invention 2 of the present invention, the breaking device may be formed such that the base slides in the axial direction of the cylindrical housing at the time of actuation and the rod enlarged-diameter portion ruptures the rupturable plate, or such that the base is fixed to the cylindrical housing, the rod and the rod enlarge-diameter portion are separated from and ejected out of the base, and the rod enlarged-diameter portion ruptures the rupturable plate.

In the case that the base moves in the axial direction, the base has a through hole in the thickness direction. The through hole is a passage hole for allowing the gas, or the like, generated from the ignition device to flow into the gas inflow space.

In the case that the base is fixed, the base has a through hole in the thickness direction in the central portion, and the rod is inserted in the through hole. The through hole after the rod is ejected serves as a passage hole for allowing the gas, or the like, generated from the ignition device to flow into the gas inflow space.

When the gas generator of present invention is used in an airbag apparatus of a vehicle, the gas generator maintains the reliability of actuation over the service period of the vehicle.

### Embodiments of Invention

In a gas generator 1 depicted in FIG. 1, an ignition device chamber 30, a gas inflow chamber 40 and a pressurized gas chamber 50 are arranged in the above order from the side of an igniter 25, inside a cylindrical housing 10.

The cylindrical housing 10 includes an ignition device chamber housing 11 and a pressurized gas chamber housing 12, but the overall housing may be formed by a single element.

In the ignition device chamber housing 11, the electric igniter 25 is fixed to an opening at a first end 11a.

A second end 12a of the pressurized gas chamber housing 12 is closed (a closing surface 13).

An opening at a second end 11b of the ignition device chamber housing 11 and an opening at a first end 12b of the pressurized gas chamber housing 12 are integrated by welding in a joint portion 14.

The cylindrical housing 10 (the ignition device chamber housing 11 and the pressurized gas chamber housing 12) is formed of iron, stainless steel, or the like.

The inside of the pressurized gas chamber 50 is filled with a gas such as argon or helium under a high pressure.

The gas is loaded from a gas filling hole in the closing surface 13 of the pressurized gas chamber housing 12.

A pin 15 is inserted into the gas filling hole after the gas is filled, and then welded together with the closing surface 13 to close the gas filling hole.

A rupturable plate 47 closes between the pressurized gas chamber 50 and the gas inflow chamber 40.

The rupturable plate 47 is formed of iron, stainless steel, or the like, and a circumferential edge 48 of the rupturable plate is fixed by welding to the ignition device chamber housing 11.

The rupturable plate 47 is curved to the gas inflow chamber 40 due to the pressure of the pressurized gas filled in the pressurized gas chamber 50.

The gas inflow chamber 40 is a space into which the gas from the pressurized gas chamber 50 and combustion gas from the ignition device chamber 30 flow at the time of actuation.

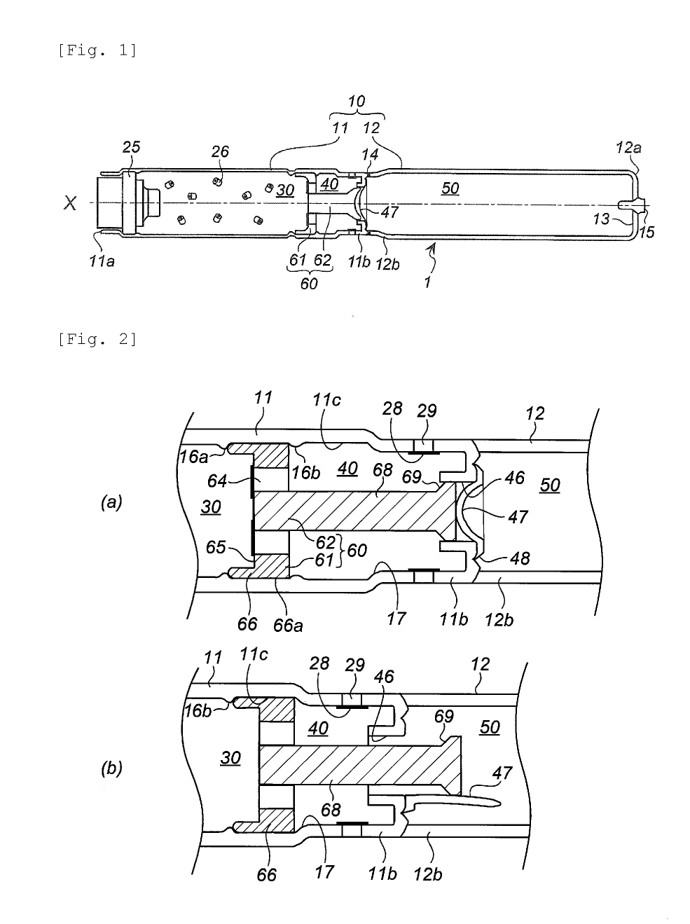

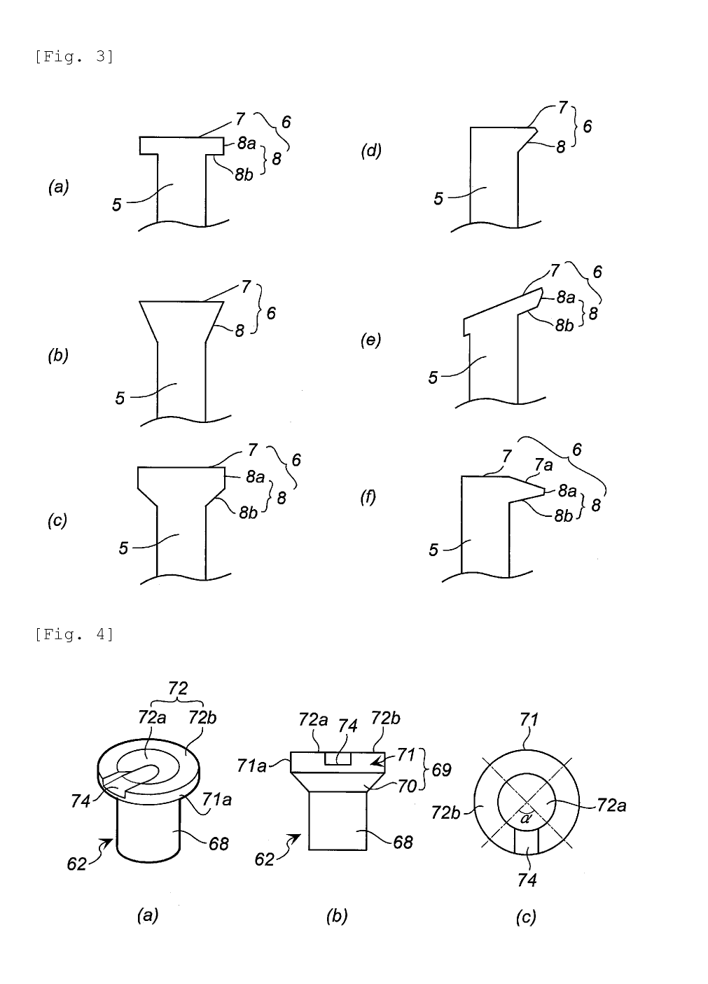

As depicted in FIG. 2, a plurality of gas discharge ports 29 are formed at the locations facing the gas inflow chamber 40 in the ignition device chamber housing 11.

The plurality of the gas discharge ports 29 are formed equidistantly in the circumferential direction of the ignition device chamber housing 11 and closed from the inside with a seal tape 28.

A cylindrical filter may be disposed at a position such as to cover the plurality of the gas discharge ports 29 from the inside.

In the gas inflow chamber 40, a step portion 17 is located between the ignition device chamber 20 and the rupturable plate 47. The step portion 17 is obtained by reducing the inner diameter of the ignition device chamber housing 11 between the ignition device chamber 20 and the rupturable plate 47. A plurality of protrusions protruding inward from an inner circumferential wall surface 11c of the ignition device chamber housing 11 may be formed instead of the step portion 17.

A breaking device 60 including a base 61 and a rod 62 extending from the base 61 towards the rupturable plate 47 is disposed between the gas inflow chamber 40 and the ignition device chamber 30.

In the breaking device 60 depicted in FIGS. 1 to 3, the base 61 and the rod 62 are integrated, but the base 61 and the rod 62 as separate members may be combined. In such a case, the rod 62 is prevented from separating from the base 61 at the time of actuation.

The base 61 includes a disk portion 65 having a plurality of through holes 64 in the thickness direction and a cylindrical wall surface portion 66 extending from the outer circumferential edge of the disk portion 65 toward the igniter 25.

The through holes 64 are closed, from the ignition device chamber 30, with a seal tape formed of aluminum.

In the base 61, an outer circumferential surface 66a of the cylindrical wall surface portion 66 abuts against the inner circumferential wall surface 11c of the ignition device chamber housing 11 such that the base 61 can slide in the X-axis direction. Since the length of the cylindrical wall surface portion 66 in the X-axis direction is larger than the thickness of the disk portion 65, the base 61 slides parallel to the X-axis and the rod 62 is not inclined with respect to the X-axis.

The cylindrical wall surface portion 66 is held from both sides in the thickness direction by two protrusions 16a and 16b protruding inward at a distance from each other from the inner circumferential wall surface 11c of the ignition device chamber housing 11.

A sealing agent is coated to ensure air tightness between the outer circumferential surface 66a of the cylindrical wall surface portion 66 and the inner circumferential wall surface 11c of the ignition device chamber housing 11.

The rod 62 has a rod main body portion 68 extending from the base 61 and a rod enlarged-diameter portion 69 with a diameter enlarged radially outward from the rod main body portion 68.

The rod enlarged-diameter portion 69 is disposed so as to directly face the rupturable plate 47 at a distance therefrom in the X-axis direction.

An outer diameter (d2) of the rod enlarged-diameter portion is slightly smaller than an inner diameter (d1) of a gas outflow port 46 (see FIG. 2) between the pressurized gas chamber 50 and the gas inflow chamber 40 (d1>d2, and d1/d2 is a numerical value close to 1).

The outer diameter of the rod enlarged-diameter portion 69 can be about 1.2 to 1.5 times the outer diameter of the rod main body portion 68.

The rod main body portion 68 and the rod enlarged-diameter portion 69 of the rod 62 depicted in FIGS. 1 and 2 can be, for example, one of the embodiments depicted in (a) to (f) in FIG. 3.

A rod depicted in (a) in FIG. 3 has a rod main body portion 5 and a disk-shaped rod enlarged-diameter portion 6 which is enlarged in diameter with respect to the rod main body portion 5 over the entire circumferential direction. The disk-shaped rod enlarged-diameter portion 6 has a distal end surface portion 7 and a circumferential wall portion 8. The circumferential wall portion 8 includes a circumferential surface 8a and a reverse surface 8b with respect to the distal end surface portion 7.

A rod depicted in (b) in FIG. 3 has a rod main body portion 5 and a rod enlarged-diameter portion 6 in the form of a truncated cone which is enlarged in diameter with respect to the rod main body portion 5 over the entire circumferential direction. The rod enlarged-diameter portion 6 in the shape of a truncated cone has a distal end surface portion 7 and a circumferential wall portion (an inclined circumferential wall portion) 8 which reduces in outer diameter towards the rod main body portion 5.

A rod depicted in (c) in FIG. 3 has a rod main body portion 5 and a rod enlarged-diameter portion 6 which is enlarged in diameter with respect to the rod main body portion 5 over the entire circumferential direction. The rod enlarged-diameter portion 6 has a distal end surface portion 7 and a circumferential wall portion 8. The circumferential wall portion 8 includes a circumferential wall 8a perpendicular to the distal end surface portion 7 and an inclined surface 8b extending from the circumferential wall 8a to the rod main body portion 5.

A rod depicted in (d) in FIG. 3 has a rod main body portion 5 and an enlarged-diameter portion 6 which is enlarged in diameter with respect to the rod main body portion 5 only in one direction. The enlarged-diameter portion 6 has the distal end surface portion 7 and the circumferential wall portion 8. The central axis of the rod main body portion 5 and the center of the distal end surface portion 7 do not coincide with each other.

An distal end portion of a rod main body portion 5 of a rod depicted in (e) in FIG. 3 has a rod enlarged-diameter portion 6 with the distal end surface portion 7 inclined with respect to the central axis of the rod main body portion 5. The rod enlarged-diameter portion 6 has a distal end surface portion 7 and a circumferential wall portion 8 (circumferential wall portions 8a and 8b). The central axis of the rod main body portion 5 and the center of the distal end surface portion 7 do not coincide with each other.

A distal end portion of a rod main body portion 5 of a rod depicted in (f) in FIG. 3 has a rod enlarged-diameter portion 6 which is enlarged in diameter only in one direction from the distal end portion. The rod enlarged-diameter portion 6 has a distal end surface portion 7 and a circumferential wall portion 8 (circumferential wall portions 8a and 8b). Part of a distal end surface portion 7 is an inclined surface 7a, and the inclined surface 7a is formed between the distal end surface portion 7 and the circumferential wall portion 8. The inclined surface 7a also functions as a non-breaking portion. The central axis of the rod main body portion 5 and the center of the distal end surface portion 7 do not coincide with each other.

Each of the rods depicted in (a) to (f) in FIG. 3 has, in the portion including the circumferential region of the distal end surface portion 7, a non-breaking portion selected from a concave portion, a cut portion and a curved surface, and a breaking portion in the remaining portion.

In the ignition device chamber 30, the igniter 25 is fixed at the first end 11a, and the opposite side thereof in the X-axis direction is partitioned by the base 61.

The inside of the ignition device chamber 30 is filled with a predetermined amount of a molded article of a gas generating agent 26.

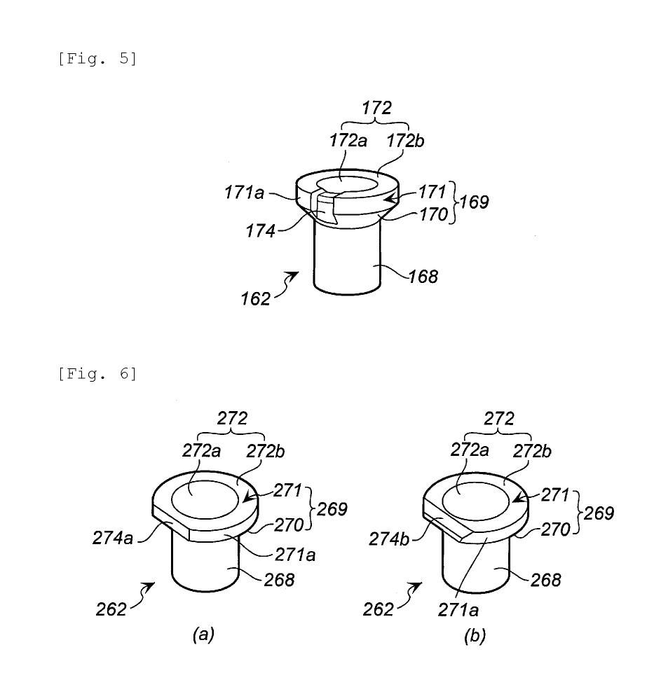

Embodiments of the rod 62 of the breaking device 60 which is used in the gas generator depicted in FIGS. 1 and 2 will be explained hereinbelow.

<Embodiment Depicted in FIG. 4>

As depicted in (a) and (b) in FIG. 4, the rod 62 has a rod main body portion 68 extending from the base 61 depicted in FIGS. 1 and 2 and a rod enlarged-diameter portion 69 with a diameter enlarged radially outward with respect to the rod main body portion 68.

The rod enlarged-diameter portion 69 has an annular inclined surface portion 70 extending from the rod main body portion 68 and a disk portion 71 extending from the maximum-diameter portion of the annular inclined surface portion 70. The annular inclined surface portion 70 and a circumferential surface 71a of the disk portion form a circumferential wall portion.

A front surface (a reverse surface of the attachment portion of the rod main body portion 68) of the disk portion 71 has a distal end surface portion 72 containing an inside circular portion 72a including the center, and an annular surface portion 72b outside the inside circular portion 72a. The inside circular portion 72a as a whole is a spherical surface receding in the thickness direction.

Part of the annular surface portion 72b has a concave portion 74 which is concaved in the thickness direction, and the concave portion 74 extends to the center of the inside circular portion 72a.

As depicted in (c) in FIG. 4, a circumferential extent of the concave portion 74 is in such a range that an angle α around the center of the distal end surface portion 72 is 100 degrees or less (in FIG. 4, the angle α is 45 degrees or less).

The rod main body portion 68 and the rod enlarged-diameter portion 69 depicted in FIG. 4 represent the embodiment depicted in (c) in FIG. 3, but the concave portion 74 can be also provided in the other embodiments depicted in FIG. 3. The concave portion 74 serves as a non-breaking portion. A boundary between the circumferential surface 71a and the distal end surface portion 72 excluding the concave portion 74 is a corner portion extending along the circumference. This corner portion serves as a breaking portion.

<Embodiment Depicted in FIG. 5>

As depicted in FIG. 5, a rod 162 has a rod main body portion 168 extending from a base (not depicted in the drawing) and a rod enlarged-diameter portion 169 with a diameter enlarged radially outward with respect to the rod main body portion 168.

The rod enlarged-diameter portion 169 has an annular inclined surface portion 170 extending from the rod main body portion 168 and a disk portion 171 extending from the maximum-diameter portion of the annular inclined surface portion 170. The annular inclined surface portion 170 and a circumferential surface 171a of the disk portion form a circumferential wall portion.

The disk portion 171 has a distal end surface portion 172 containing an inside circular portion 172a including the center and an annular surface portion 172b outside the inside circular portion 172a. The inside circular portion 172a as a whole is a spherical surface receding in the thickness direction.

Part of the annular surface portion 172b has a concave portion 174 which is concaved in the thickness direction, and the concave portion 174 is formed in the annular surface portion 172b, but is not formed in the inside circular portion 172a.

Similarly to the embodiment depicted in (c) in FIG. 4, a circumferential extent of the concave portion 174 is in such a range that an angle α around the center of the distal end surface portion 172 is 100 degrees or less (in FIG. 5, the angle α is 45 degrees or less).

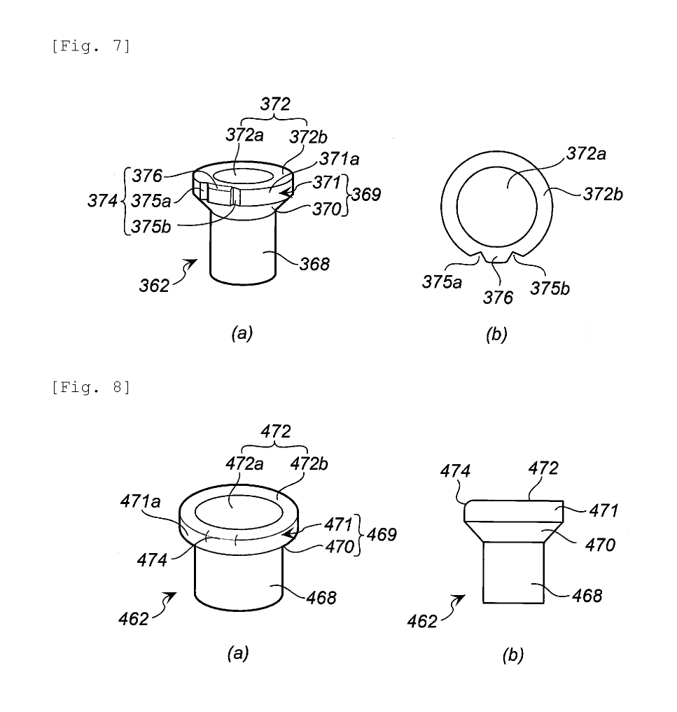

The rod main body portion 168 and the rod enlarged-diameter portion 169 depicted in FIG. 5 represent the embodiment depicted in (c) in FIG. 3, but the concave portion 174 can be provided in the other embodiments depicted in FIG. 3. The concave portion 174 serves as a non-breaking portion. A boundary between the circumferential surface 171a and the distal end surface portion 172 excluding the concave portion 174 is a corner portion extending along the circumference. This corner portion serves as a breaking portion.

<Embodiment Depicted in FIG. 6>

As depicted in (a) in FIG. 6, a rod 262 has a rod main body portion 268 extending from a base (not depicted in the drawing) and a rod enlarged-diameter portion 269 with a diameter enlarged radially outward with respect to the rod main body portion 268.

The rod enlarged-diameter portion 269 has an annular inclined surface portion 270 extending from the rod main body portion 268 and a disk portion 271 extending from the maximum-diameter portion of the annular inclined surface portion 270. The annular inclined surface portion 270 and a circumferential surface 271a of the disk portion form a circumferential wall portion.

The disk portion 271 has a distal end surface portion 272 containing an inside circular portion 272a including the center and an annular surface portion 272b outside the inside circular portion 272a. The inside circular portion 272a as a whole is a spherical surface receding in the thickness direction.

Part of the annular surface portion 272b has a cut portion 274a which is cut in the direction perpendicular to the annular surface portion 272b. The cut portion 274a is obtained by cutting through both the disk portion 271 and the annular inclined surface portion 270.

Similarly to the embodiment depicted in (c) in FIG. 4, a circumferential extent of the cut portion 274a is in such a range that an angle α around the center of the distal end surface portion 272 is 100 degrees or less.

The rod main body portion 268 and the rod enlarged-diameter portion 269 depicted in (a) in FIG. 6 represent the embodiment depicted in (c) in FIG. 3, but the cut portion 274a can be provided in the other embodiments depicted in FIG. 3. The cut portion 274a serves as a non-breaking portion. A boundary between the circumferential surface 271a and the distal end surface portion 272 excluding the cut portion 274a is a corner portion extending along the circumference. This corner portion serves as a breaking portion.

The rod 262 depicted in (b) in FIG. 6 is the same as the rod depicted in (a) in FIG. 6, except that a cut portion 274b is cut obliquely with respect to the annular surface portion 272b. The cut portion 274b is obtained by cutting obliquely only the disk portion 271. A circumferential extent of the cut portion 274b is in such a range that an angle α around the center of the distal end surface portion 272 is 100 degrees or less, but it can be in such a range that the angle is more than 100 degrees and less than 180 degrees. The cut portion 274b may be a curved surface.

The rod main body portion 268 and the rod enlarged-diameter portion 269 depicted in (b) in FIG. 6 represent the embodiment depicted in (c) in FIG. 3, but the cut portion 274b can be provided in the other embodiments depicted in FIG. 3. The cut portion 274b serves as a non-breaking portion. A boundary between the circumferential surface 271a and the distal end surface portion 272 excluding the cut portion 274b is a corner portion extending along the circumference. This corner portion serves as a breaking portion.

<Embodiment Depicted in FIG. 7>

As depicted in FIG. 7, a rod 362 has a rod main body portion 368 extending from a base (not depicted in the drawing) and a rod enlarged-diameter portion 369 with a diameter enlarged radially outward with respect to the rod main body portion 368.

The rod enlarged-diameter portion 369 has an annular inclined surface portion 370 extending from the rod main body portion 368 and a disk portion 371 extending from the maximum-diameter portion of the annular inclined surface portion 370. The annular inclined surface portion 370 and a circumferential surface 371a of the disk portion form a circumferential wall portion.

The disk portion 371 has a distal end surface portion 372 containing an inside circular portion 372a including the center and an annular surface portion 372b outside the inside circular portion 372a. The inside circular portion 372a as a whole is a spherical surface receding in the thickness direction.

Part of the annular surface portion 372b has a concave portion 374 formed in the thickness direction of the annular surface portion 372b.

The concave portion 374 has two notches, namely, a first notch 375a and a second notch 375b, which are formed at a distance from each other in the circumferential direction of the annular surface portion 372b, and a cut portion 376 obtained by cutting out obliquely the surface of the portion between the first notch 375a and the second notch 375b in the circumferential direction.

The cut portion 376 is obtained by cutting obliquely only the disk portion 371.

Similarly to the embodiment depicted in (c) in FIG. 4, a circumferential extent of the concave portion 374 is in such a range that an angle α around the center of the distal end surface portion 372 is 100 degrees or less, but it can be in such a range that the angle is more than 100 degrees and less than 180 degrees.

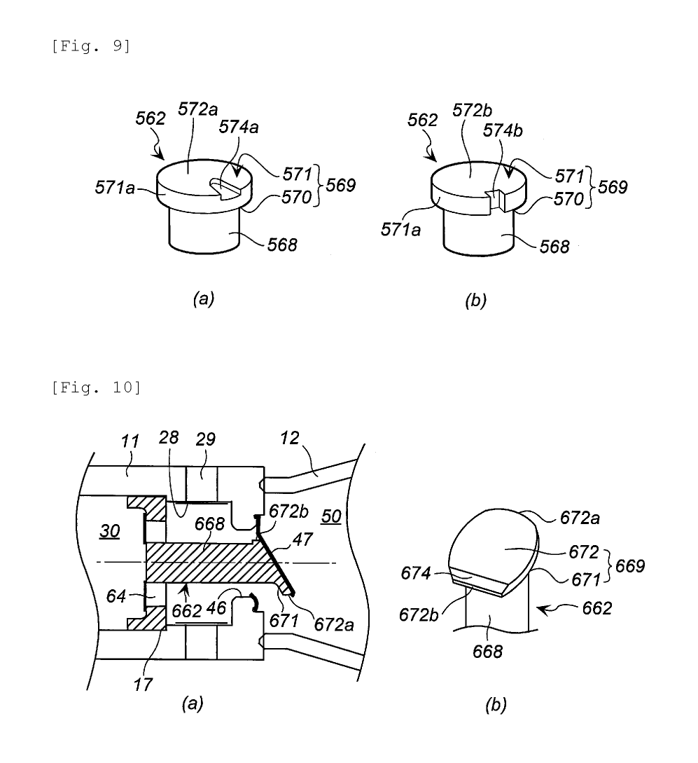

The rod main body portion 368 and the rod enlarged-diameter portion 369 depicted in FIG. 7 represent the embodiment depicted in (c) in FIG. 3, but the cut portion 376 can be provided in the other embodiments depicted in FIG. 3. The cut portion 374, the first notch 375a, and the second notch 375b serve as non-breaking portions. A boundary between the circumferential surface 371a and the distal end surface portion 372 excluding the non-breaking portions is a corner portion extending along the circumference. This corner portion serves as a breaking portion.

<Embodiment Depicted in FIG. 8>

As depicted in FIG. 8, a rod 462 has a rod main body portion 468 extending from a base (not depicted in the drawing) and a rod enlarged-diameter portion 469 with a diameter enlarged radially outward with respect to the rod main body portion 468.

The rod enlarged-diameter portion 469 has an annular inclined surface portion 470 extending from the rod main body portion 468 and a disk portion 471 extending from the maximum-diameter portion of the annular inclined surface portion 470. The annular inclined surface portion 470 and a circumferential surface 471a of the disk portion form a circumferential wall portion.

The disk portion 471 has a distal end surface portion 472 containing an inside circular portion 472a including the center and an annular surface portion 472b outside the inside circular portion 472a. The inside circular portion 472a as a whole is a spherical surface receding in the thickness direction.

Part of the outer circumferential portion of the annular surface portion 472b has no corner and is provided with a curved portion 474 which is rounded.

Similarly to the embodiment depicted in (c) in FIG. 4, a circumferential extent of the curved portion 474 is in such a range that an angle α around the center of the distal end surface portion 472 is 100 degrees or less (in FIG. 8, the angle α is 45 degrees or less).

The rod main body portion 468 and the rod enlarged-diameter portion 469 depicted in FIG. 8 represent the embodiment depicted in (c) in FIG. 3, but the curved portion 474 can be provided in the other embodiments depicted in FIG. 3. The curved portion 474 serves as a non-breaking portion. A boundary between the circumferential surface 471a and the distal end surface portion 472 excluding the curved portion 474 is a corner portion extending along the circumference. This corner portion serves as a breaking portion.

<Embodiment Depicted in FIG. 9>

As depicted in (a) in FIG. 9, a rod 562 has a rod main body portion 568 extending from a base (not depicted in the drawing) and a rod enlarged-diameter portion 569 with a diameter enlarged radially outward with respect to the rod main body portion 568.

The rod enlarged-diameter portion 569 has a disk portion 571 extending from the rod main body portion 568. A circumferential surface 571a forms a circumferential wall portion, and the surface including a concave portion 574a serves as a distal end surface portion 572a. The distal end surface portion 572a is flat and has no recess and the like.

Part of the surface including the peripheral portion of the disk portion 571 has a concave portion 574a which is concaved in the thickness direction.

Similarly to the embodiment depicted in (c) in FIG. 4, a circumferential extent of the concave portion 574a is in such a range that an angle α around the center of the distal end surface portion 572a is 100 degrees or less (in (a) in FIG. 9, the angle α is 45 degrees or less).

The rod main body portion 568 and the rod enlarged-diameter portion 569 depicted in (a) in FIG. 9 represent the embodiment depicted in (a) in FIG. 3, but the concave portion 574a can be provided in the other embodiments depicted in FIG. 3. The concave portion 574a serves as a non-breaking portion. A boundary between the circumferential surface 571a and the distal end surface portion 572a excluding the concave portion 574a is a corner portion extending along the circumference. This corner portion serves as a breaking portion.

As depicted in (b) in FIG. 9, a rod has the rod main body portion 568 extending from a base (not depicted in the drawing) and the rod enlarged-diameter portion 569 with a diameter enlarged radially outward with respect to the rod main body portion 568.

The rod enlarged-diameter portion 569 has the disk portion 571 extending from the rod main body portion 568. A surface including the circumferential surface 571a forms a circumferential wall portion, and the surface including a cut portion 574b corresponds to a distal end surface portion 572b. The distal end surface portion 572b is flat and has no recess and the like.

Part of the surface including the peripheral portion of the disk portion 571 has the quadrangular cut portion 574b receding in the thickness direction.

Similarly to the embodiment depicted in (c) in FIG. 4, a circumferential extent of the cut portion 574b is in such a range that an angle α around the center of the disk portion 571 is 100 degrees or less (in (b) in FIG. 9, the angle α is 45 degrees or less).

The rod main body portion 568 and the rod enlarged-diameter portion 569 depicted in (a) in FIG. 9 represent the embodiment depicted in (a) in FIG. 3, but the cut portion 574b can be provided in the other embodiments depicted in FIG. 3. The cut portion 574b serves as a non-breaking portion. A boundary between the circumferential surface 571a and the distal end surface portion 572b excluding the cut portion 574b is a corner portion extending along the circumference. This corner portion serves as a breaking portion.

The operation of the gas generator depicted in FIG. 1 will be explained with reference to FIG. 2 and FIGS. 4 to 9.

The molded article of the gas generating agent 26 is ignited and burned by the combustion products generated by the actuation of the igniter 25, and a high-temperature combustion gas is produced.

When the pressure inside the ignition device chamber 30 is raised by the combustion gas, the base 61 of the breaking device 60 moves over the protrusion 16b and slides to move along the inner circumferential wall surface 11c of the ignition device chamber housing in the X-axis direction.

The base 61 then stops as a result of collision with the step portion 17 which has a reduced inner diameter, but the rod 62 (the rod enlarged-diameter portion 69 of the rod main body portion 68) collides with and ruptures the rupturable plate 47.

When the breaking device including the rod 62 depicted in FIG. 4 is used, the breaking device operates in the following manner.

As depicted in (a) in FIG. 2, the rupturable plate 47 is curved towards the gas inflow chamber 40. The inside disk portion 72a having the recess and the annular surface portion 72b (the breaking portion) of the distal end surface portion 72 depicted in FIG. 4 collide with the rupturable plate 47, and the rupturable plate 47 deforms towards the pressurized gas chamber 50. In this case, the portion of the annular surface portion 72b in which the concave portion 74 is present (the non-breaking portion) does not collide, or even if it collides with the rupturable plate 47, an impact applied thereby to the rupturable plate 47 is less than that by the corner portion on the periphery of the annular surface portion 72b excluding the concave portion.

For this reason, the portion of the rupturable plate 47 which is directly opposite to the concave portion 74 is not ruptured, while the other portion is ruptured. As a result, the ruptured portion is bent toward the pressurized gas chamber 50 and opened while the unruptured portion remains.

The gas inside the pressurized gas chamber 50 then flows into the gas inflow chamber 40 through the space between the gas outflow port 46 and the rod main body portion 68 after the rupturable plate 47 is ruptured and opened ((b) in FIG. 2).

In parallel with this, the seal tape closing the through holes 64 of the base 61 is broken and the combustion gas flows from the through holes 64 into the gas inflow chamber 40.

The combustion gas and the pressurized gas flowing into the gas inflow chamber 40 are discharged from the gas discharge port 29.

It can be considered that the combustion gas and the pressurized gas are discharged such that, after part of either one of the gases is discharged from the gas discharge ports 29, the remaining gases are discharged as a gas mixture. However, the gas discharge state or timing is not limited.

When the breaking device including the rod 162 depicted in FIG. 5 is used instead of the rod 62 depicted in FIG. 4 in the operation illustrated by (a) and (b) in FIG. 2, the breaking device operates in the following manner.

The inside disk portion 172a having the recess and the annular surface portion 172b (the breaking portion) of the distal end surface portion 172 collide with the rupturable plate 47, a portion of the annular surface portion 172b in which the concave portion 174 is present (the non-breaking portion) collides, and the rupturable plate 47 deforms towards the pressurized gas chamber 50. In this case, even when the concave portion 174 collides with the rupturable plate 47, an impact applied thereby to the rupturable plate 47 is less than that by the corner portion on the periphery of the annular surface portion 172b excluding the concave portion 174.

For this reason, the portion of the rupturable plate 47 which is directly opposite to the concave portion 174 is not ruptured (the unruptued portion), while the other portion is ruptured. As a result, a state similar to that depicted in (b) in FIG. 2 is assumed and the unruptured portion remains while the other portion is bent towards the pressurized gas chamber 50 and the gas outflow port 46 is opened.

When the breaking device including the rod 262 depicted in (a) and (b) in FIG. 6 is used instead of the rod 62 depicted in FIG. 4 in the operation illustrated by (a) and (b) in FIG. 2, the breaking device operates in the following manner.

The inside disk portion 272a having the recess and the annular surface portion 272b (the breaking portion) of the distal end surface portion 272 collide with the rupturable plate 47 and the rupturable plate 47 deforms towards the pressurized gas chamber 50. In this case, the portion of the annular surface portion 272b in which the cut portion 274a or the cut portion 274b is present (the non-breaking portion) does not collide, or even when it collides with the rupturable plate 47, an impact applied thereby to the rupturable plate 47 is less than that by the corner portion on the periphery of the annular surface portion 272b excluding the concave portion.

For this reason, the portion of the rupturable plate 47 which is directly opposite to the cut portion 274a or the cut portion 274b is not ruptured (the unruptured portion) while the other portion is ruptured. As a result, a state similar to that depicted in (b) in FIG. 2 is assumed, and the unruptured portion remains while the other portion is bent towards the pressurized gas chamber 50 and the gas outflow port 46 is opened.

When the breaking device including the rod 362 depicted in FIG. 7 is used instead of the rod 62 depicted in FIG. 4 in the operation illustrated by (a) and (b) in FIG. 2, the breaking device operates in the following manner.

The inside disk portion 372a having the recess and the annular surface portion 372b (the breaking portion) of the distal end surface portion 372 collide with the rupturable plate 47 and the rupturable plate 47 deforms towards the pressurized gas chamber 50. In this case, the portion of the annular surface portion 372b in which the concave portion 374 is present (the non-breaking portion) does not collide, or even when it collides with the rupturable plate 47, an impact applied thereby to the rupturable plate 47 is less than that by the corner portion on the periphery of the annular surface portion 372b excluding the concave portion.

For this reason, the portion of the rupturable plate 47 which is directly opposite to the concave portion 374 is not ruptured while the other portion is ruptured. As a result, a state similar to that depicted in (b) in FIG. 2 is assumed and the unruptured portion remains while the ruptured portion is bent towards the pressurized gas chamber 50 and the gas outflow port 46 is opened.

When the breaking device including the rod 462 depicted in FIG. 8 is used instead of the rod 62 depicted in FIG. 4 in the operation illustrated by (a) and (b) in FIG. 2, the breaking device operates in the following manner.

The inside disk portion 472a having the recess and the annular surface portion 472b (the breaking portion) of the distal end surface portion 472 collide with the rupturable plate 47 and the rupturable plate 47 deforms towards the pressurized gas chamber 50. In this case, the portion of the annular surface portion 472b where the curved portion 474 is present (the non-breaking portion) does not collide, or even when it collides with the rupturable plate 47, an impact applied thereby to the rupturable plate 47 is less than that by the corner portion on the periphery of the annular surface portion 472b which is the remaining portion excluding the curved portion.

For this reason, the portion of the rupturable plate 47 which is directly opposite to the curved portion 474 is not ruptured, while the other portion is ruptured. As a result, a state similar to that depicted in (b) in FIG. 2 is assumed and the unruptured portion remains while the ruptured portion is bent towards the pressurized gas chamber 50 and the gas outflow port 46 is opened.

When the breaking device including the rod 562 depicted in (a) and (b) in FIG. 9 is used instead of the rod 62 depicted in FIG. 4 in the operation illustrated by (a) and (b) in FIG. 2, the breaking device operates in the following manner.

The central parts of the distal end surface portions 572a and 572b and the central part of the deformed rupturable plate 47 collide with each other, and the rod 562 (the enlarged-diameter portion 569) then moves towards the pressurized gas chamber 50 while pushing the rupturable plate 47. In this process, the distal end surface portion 572a (the breaking portion) collides with the rupturable plate 47 and the rupturable plate 47 deforms towards the pressurized gas chamber 50. In this case, the portion in which the concave portion 574a or the cut portion 574b is present (the non-breaking portion) does not collide, or even when it collides with the rupturable plate 47, an impact applied thereby to the rupturable plate 47 is less than that by the corner portion on the periphery of the annular surface portion 573 excluding the curved portion.

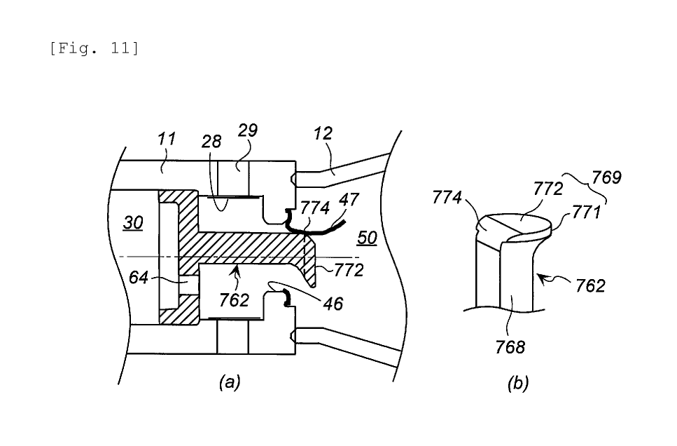

For this reason, the portion of the rupturable plate 47 which is directly opposite to the concave portion 574a or the cut portion 574b is not ruptured, while the other portion is ruptured. As a result, a state similar to that depicted in (b) in FIG. 2 is assumed and the unruptured portion remains while the ruptured portion is bent towards the pressurized gas chamber 50 and the gas outflow port 46 is opened.

<Embodiment Depicted in FIG. 10>

The operation of the embodiment, in which a rod 662 depicted in (b) in FIG. 10 is used instead of the rod 62 depicted in FIG. 4 in the operation illustrated by (a) and (b) in FIG. 2, will be described hereinbelow with reference to (a) in FIG. 10.

The rod 662 depicted in (b) in FIG. 10 corresponds to the rod depicted in (e) in FIG. 3.

The distal end portion of a rod main body portion 668 of the rod 662 has a rod enlarged-diameter portion 669 having a flat surface (a distal end surface portion 672) inclined with respect to the central axis of the rod main body portion (a distal end portion) 668 and a circumferential wall portion 671.

The distal end surface portion 672 of the rod enlarged-diameter portion 669 has a portion (a distal end portion 672a), which is the closest to the rupturable plate 47, and a portion (a rear end portion 672b) which is the farthest from the rupturable plate 47 in a positional relation with respect to the rupturable plate 47.

A cut portion 674 is formed at the rear end portion 672b of the distal end surface portion 672. The cut portion 674 is a surface inclined with respect to the distal end surface portion 672.

Before the actuation, the rod enlarged-diameter portion 669 is disposed such that the distance from the rupturable plate 47 increases from the distal end portion 672a to the rear end portion 672b.

At the time of actuation, the distal end portion 672a in the distal end surface portion 672 of the rod enlarged-diameter portion 669, which is the closest to the rupturable plate 47, collides first and the rear end portion 672b which is the farthest from the rupturable plate 47 collides last with the rupturable plate 47. In this case, the cut portion 674 (the non-breaking portion) does not collide, or even when it collides with the rupturable plate 47, an impact applied thereby to the rupturable plate 47 is less than that by the corner portion on the periphery of the distal end surface portion 672 excluding the rear end portion.

For this reason, the portion of the rupturable plate 47 which is directly opposite to the cut portion 674 is not ruptured while the other portion is ruptured. As a result, the ruptured portion is pushed by the distal end surface portion 672 and bent towards the pressurized gas chamber 50, and the gas outflow port 46 is opened while the unruptured portion remains.

<Embodiment Depicted in FIG. 11>

The operation of the embodiment in which a rod 762 depicted in (b) in FIG. 11 is used instead of the rod 62 depicted in FIG. 4 in the operation illustrated by (a) and (b) in FIG. 2 will be described hereinbelow with reference to (a) in FIG. 11.

The rod 762 depicted in (b) in FIG. 11 corresponds to the rod depicted in (d) in FIG. 3.

The distal end portion of a rod main body portion 768 of the rod 762 has a rod enlarged-diameter portion 769 having a distal end surface portion 772 which is enlarged in diameter only in one direction from the central axis of the rod main body portion (a distal end portion) 768 and a circumferential wall portion 771.

A curved portion 774 functioning as a non-breaking portion is formed at one end of the distal end surface portion 772.

When the distal end surface portion 772 of the rod enlarged-diameter portion 769 collides at the time of actuation, the rupturable plate 47 deforms towards the pressurized gas chamber 50. In this case, the curved portion 774 does not collide, or even when it collides with the rupturable plate 47, an impact applied thereby to the rupturable plate 47 is less than that by the corner portion on the periphery of the distal end surface portion 772.

For this reason, the portion of the rupturable plate 47 which is directly opposite to the curved portion 774 is not ruptured while the other portion is ruptured. As a result, the ruptured portion is pushed by the curved portion 774 and bent towards the pressurized gas chamber 50, and the gas outflow port 46 is opened while the unruptured portion remains. The portion of the rod main body portion 768 in which the curved portion 774 is formed is a flat surface extending in the axial direction.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator, comprising:
a cylindrical housing having an ignition device which is fixed to an opening at a first end, and a second end which is closed on an axially opposite side of the first end, the inside of the cylindrical housing being provided with an ignition device chamber provided with the ignition device, a gas inflow chamber having a gas discharge port and a pressurized gas chamber, these chambers being arranged in the above order from the first end;
a rupturable plate closing a gas outflow port between the pressurized gas chamber and the gas inflow chamber; and
a breaking device arranged between the ignition device chamber and the gas inflow chamber, the breaking device including, a base, whose outer circumferential surface abuts against an inner circumferential wall surface of the cylindrical housing, and a rod extending from the base towards the rupturable plate, the rod including a rod main body portion and a rod enlarged-diameter portion with a diameter enlarged radially at a distal end portion of the rod main body portion,
the rod enlarged-diameter portion including a distal end surface portion facing the rupturable plate and a circumferential wall portion extending from the distal end surface portion to the rod main body portion,
the distal end surface portion of the rod enlarged-diameter portion including a breaking portion and a non-breaking portion for the rupturable plate,
the non-breaking portion being a concave portion which is formed in a portion including a circumferential region of the distal end surface portion and being concaved in a thickness direction, and the breaking portion corresponding to the remaining portion of the distal end surface portion excluding the concave portion,
a circumferential extent in which the non-breaking portion is formed as the concave portion being in such a range that an angle around the center of the distal end surface portion is not more than 100 degrees.

2. The gas generator according to claim 1, wherein the non-breaking portion of the distal end surface portion of the rod enlarged-diameter portion is a cut portion that is cut perpendicularly or obliquely through the distal end surface portion of the rod enlarged-diameter portion including a circumferential region.

3. The gas generator according to claim 1, wherein the non-breaking portion of the distal end surface portion of the rod enlarged-diameter portion is a curved portion formed in a boundary between the distal end surface portion and the circumferential wall portion.

4. The gas generator according to claim 1, wherein the distal end surface portion of the rod enlarged-diameter portion is a flat surface perpendicular to a central axis of the rod main body portion, or a flat surface inclined with respect to the central axis of the rod main body portion.

5. A gas generator, comprising:
a cylindrical housing having an ignition device which is fixed to an opening at a first end, and a second end which is closed on an axially opposite side of the first end, the inside of the cylindrical housing being provided with an ignition device chamber provided with the ignition device, a gas inflow chamber having a gas discharge port and a pressurized gas chamber, these chambers being arranged in the above order from the first end;
a rupturable plate closing a gas outflow port between the pressurized gas chamber and the gas inflow chamber; and
a breaking device arranged between the ignition device chamber and the gas inflow chamber, the breaking device including, a base, whose outer circumferential surface abuts against an inner circumferential wall surface of the cylindrical housing, and a rod extending from the base towards the rupturable plate, the rod including a rod main body portion and a rod enlarged-diameter portion with a diameter enlarged radially at a distal end portion of the rod main body portion,
the rod enlarged-diameter portion including a distal end surface portion facing the rupturable plate and a circumferential wall portion extending from the distal end surface portion to the rod main body portion,
the distal end surface portion of the rod enlarged-diameter portion including a breaking portion and a non-breaking portion for the rupturable plate,
the non-breaking portion of the distal end surface portion of the rod enlarged-diameter portion being a cut portion that is cut in a direction perpendicular or oblique to the distal end surface portion of the rod enlarged-diameter portion, and the breaking portion being a remaining portion of the distal end surface portion excluding the cut portion,
a circumferential extent in which the non-breaking portion is formed as the cut portion being in such a range that an angle around the center of the distal end surface portion is less than 180 degrees.

6. The gas generator according to claim 5, wherein the distal end surface portion of the rod enlarged-diameter portion is a flat surface perpendicular to the central axis of the distal end portion of the rod main body portion, or a flat surface inclined with respect to the central axis of the distal end portion of the rod main body portion.
